(19) United States
(12) Patent Application Publication
(10) Pub. No.: US 2009/0034443 A1
(43) Pub. Date: Feb. 5, 2009

(54) POWER SAVING IDLE MODE ALGORITHM FOR AN ACCESS POINT

(76) Inventors: Jesse Walker, Portland, OR (US); Emily H. Qi, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/830,184

(22) Filed: Jul. 30, 2007

(51) Int. Cl. G08C 17/00; H04Q 7/24

(52) U.S. Cl. 370/311; 370/338

(57) ABSTRACT

A wireless device operating as an access point (AP) uses an idle mode service and an idle mode mechanism to provide the capability of powering down during idle times. The client and the AP may share a cooperative idle mode mechanism to efficiently manage power for all devices operating in the WLAN.

Developments in a number of different digital technologies have greatly increased the need to transfer data from one device across a network to another device or system. Technological developments permit digitization and compression of large amounts of voice, video, imaging, and datan information, which may be transmitted from laptops and other digital equipment to other devices. These developments in digital technology have stimulated a need to deliver and supply data to processing units within networks such as the Wireless Local Area Network (WLAN) networks.

With the amount of data that devices transmit, enhancements to power schemes are needed to manage power to extend battery life and improve energy efficiency. WLAN enabled mobile devices presently rely on power saving schemes, but power management for other devices in the WLAN networks are needed to increase the energy efficiency of the system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates an AP wireless device that enters a deep power saving mode or idle mode and being capable of providing network connectivity service for mobile clients;

FIG. 2 is a diagram depicting a WLAN that includes an AP to execute an algorithm to extend and enhance the idle mode mechanism to enable power saving; and

FIG. 3 is a flow diagram that illustrates the AP idle mode operation in accordance with the present invention.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

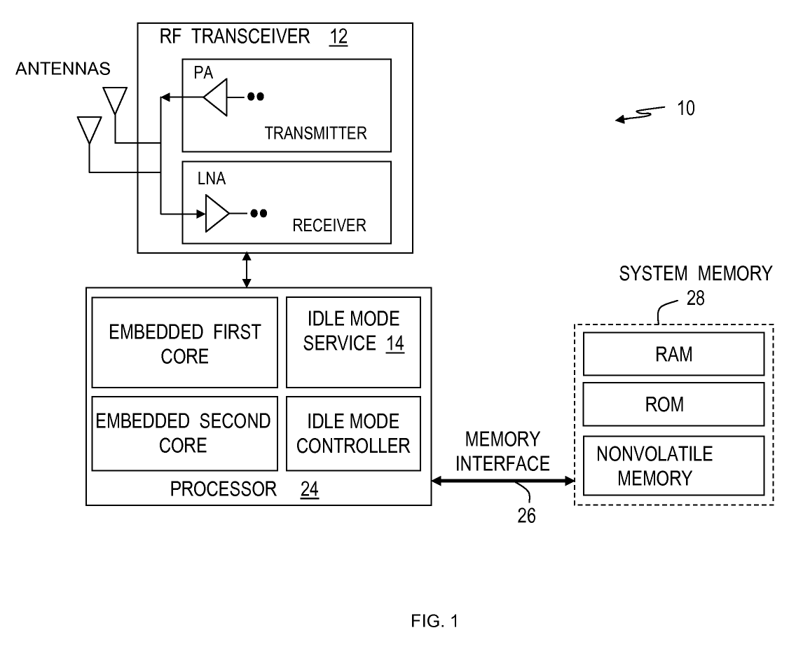

The embodiment illustrated in FIG. 1 shows a wireless communication device 10 that includes one or more radios to allow communication with other over-the-air communication devices. Communication device 10 may operate as an Access Point (AP) that enters a deep power saving mode in an idle mode and yet remains capable of activating to provide network connectivity service for mobile clients. The AP in the idle mode may turn off the radios and other associated circuitry to reduce power. The present invention may be incorporated in wireless devices that operate in networks such as, for example, Wireless Fidelity (Wi-Fi) that provides the underlying technology of Wireless Local Area Network (WLAN) based on the IEEE 802.11 specifications, WiMax and Mobile WiMax based on IEEE 802.16-2005, Wideband Code Division Multiple Access (WCDMA), and Global System for Mobile Communications (GSM) networks, although the present invention is not limited to operate in only these networks. The radio subsystems collocated in the same platform of communication device 10 provide the capability of communicating in an RF/location space with the other devices in the communications network.

The simplistic embodiment illustrates the coupling of antenna(s) to the transceiver 12 to accommodate modulation/demodulation. Analog transceiver 12 may be embedded with a processor 24 as a mixed-mode integrated circuit where the processor processes functions that fetch instructions, generates decodes, finds operands, and performs other appropriate actions, then stores results. Alternatively, the processor may be separate from transceiver 12. Processor 24 may include baseband and applications processing functions and utilize a single core or may include multiple processor cores to handle application functions and allow processing workloads to be shared across the cores. The processor may transfer data through an interface 26 to memory storage in a system memory 28.

In the presence of WiFi hotspots, wireless communication devices may operate as a STA (mobile device with WLAN access) to gain access to a private network, to a commercial network with free public access, or access based on a fee that may require roaming agreements. WiFi hotspots may be present in a variety of locations to provide access and permit voice, video, imaging, and data exchanges between devices within the WLAN network. Thus, the present invention facilitates applications that may be used in a variety of products with the claimed subject matter incorporated into laptops, smart phones, MP3 players, cameras, communicators and Personal Digital Assistants (PDAs), medical or biotech equipment, automotive safety and protective equipment, etc. However, it should be understood that the scope of the present invention is not limited to these examples.

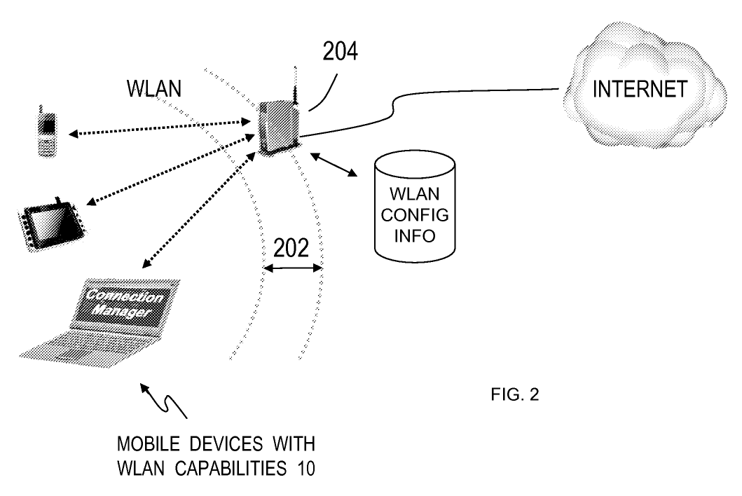

FIG. 2 illustrates a WLAN 202 where wireless communication devices may be employed. When attempting a WLAN access, the STA may scan to determine local vicinity of WLAN networks and generate a list of WLANs based on Service Set Identifiers (SSIDs) which is a sequence of characters that uniquely names a wireless LAN and differentiates one WLAN from another WLAN. As shown in the figure, any of the wireless communication devices may attempt to access the WLAN network to determine configuration information such as, for example, authentication requirements; support for online enrollment; a determination of open access or an access charge; and the preferred enrollment methods. In the figure, a WLAN access point 204 is an information server that stores WLAN network details and query information.

The power saving mode in the IEEE 802.11 standard is defined for WLAN enabled mobile devices that operate within a single Access Point (AP) coverage. For networks having more than one AP, roaming and (re)association occurs as the user moves the mobile device from one AP to another AP. The IEEE 802.11 standard provides information to discover the best available access point and mechanisms for secure and fast transitions between access points within the same Extended Service Set (ESS). Mobile devices and networks may work cooperatively during these network transitions to optimize handovers across Wi-Fi, WiMAX and cellular radios. The mobile device conducts Basic Service Set (BSS) transitions in the WLAN environment that involve scanning the available channels for the target AP, selecting the best AP, and re-association to the new AP, even though there may not be any upcoming or outgoing traffic to/from this mobile device.

However, this unnecessary BSS transition may disrupt the total system idle and cause unnecessary power consumption for re-association and scanning. To provide battery efficiency of the mobile devices included in WLAN deployment, an idle mode service 14 (see FIG. 1) is included both for mobile devices and for the AP. Idle mode service 14 is responsible for managing paging functionality such as paging requests, broadcasting paging messages, buffering of incoming packets, and triggering paging messages. The STA discovers that the WLAN network supports the paging mechanism during the network entry procedure, and then uses paging messages to control its time for staying awake. Through configuration messages the STA may receive paging context information to configure paging intervals. When in the paging mode the STA may power off its MAC and PHY, and then power back on prior to the paging interval in order to receive the paging message.

In the paging mode the STAn is not linked with any AP, and therefore, the STA system will be idle. A paging management scheme allows the STA to power off its radio and the associated circuitry for periods of time, but awakes prior to the paging interval that is advertised by the paging controller. Thus, the STAn is ready for receiving a page when there is an incoming packet, but the paging mechanism allows the STA to enter the low power mode (so-called Idle mode, which is much longer than regular Listen Interval) across multiple APs' coverage. Therefore, with the paging mechanism the power consumption of applications may be reduced compared to always-on-always-connected laptop or handheld devices.

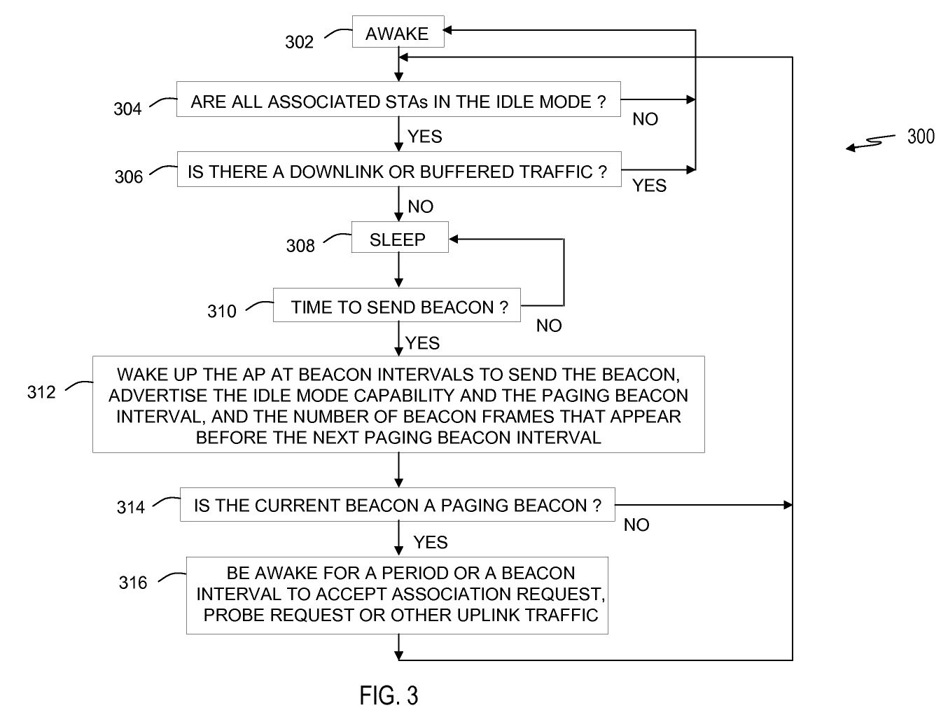

Traditionally, the AP is awake all of the time to provide the desired connectivity service to the network. The AP wakes up to advertise the beacon at every beacon interval and remains awake for a period after the paging beacon to accept any (re)association requests or other network traffic. However, if no traffic is buffered and all associated clients are in an idle mode, then it should be noted that the AP does not need to be awake all of the time. By way of example, the datan in enterprise shows the AP has active day traffic only about 50% of the time, and further, the AP has active off-business traffic about 2% of the time. Whereas the power saving mode is defined in the IEEE 802.11 standard only to enable power saving for the mobile client, the algorithm proposed in FIG. 3 extends and enhances the idle mode mechanism in accordance with the present invention to enable significant power saving for the APs. Thus, the power saving algorithm may be incorporated into communication platforms such as, for example, access points, desktop PCs, laptop PCs and Ultra-mobile PCs (UMPCs) which support mesh access points to improve battery life and energy efficiency. Accordingly, the algorithm can significantly reduce AP power consumption while the AP is idle.

FIG. 3 shows features of the algorithm that in accordance with the present invention allows the AP to enter a deep power saving mode or idle mode while still providing network connectivity service for mobile clients. The figure shows a flowchart that illustrates the algorithm or processes that may be used to schedule and control behavior for the multiple radios and associated circuitry in the AP. Method 300, or portions thereof, is performed by the radio device in combination with the idle mode service and the idle mode controller. Method 300 is not limited by the particular type of apparatus, software element, or system performing the method. Also, the various actions in method 300 may be performed in the order presented, or may be performed in a different order.

In method 300 a decision is made as to whether the AP needs to perform a service. If the AP is needed to complete a service, the AP operates in the awake mode (Block 302). A determination is made as to whether all STAs associated with the AP are in the idle mode (block 304). If all associated STAs are in idle mode and the AP doesn't have any downlink or buffered network traffic (block 306), then the AP enters the idle mode. From the idle mode the AP then conducts the following operations as shown in block 312. The AP sleeps (block 308), wakes up to send beacon every beacon interval (block 310), and then returns to sleep again (block 308). In block 312 the AP also advertises its idle mode capability, paging beacon interval, and the number of beacon frames appear before the next paging beacon interval. The paging interval may be a multiple of the regular beacon interval. As shown in block 314, it is determined whether the current beacon is a paging beacon. If the current beacon is not a paging beacon, the algorithm returns to the process in block 304. On the other hand, if the current beacon is a paging beacon the algorithm proceeds to block 316 where the AP remains awake for a period (e.g. for the entire interval before the next beacon) to accept new (re)association requests, probe requests from the idle mode station or unassociated (new visiting) station, or other uplink traffic.

With the AP operating according to the algorithm defined in the figure, if the STAn is operating in the idle mode and exits that mode to receive or transmit traffic, the STA wakes up at the time of the paging beacon delivery and sends an idle mode exit or re-association request to the AP after receiving the paging beacon. If the STAn is currently unassociated with the AP and intends to associate with the AP, the STA wakes up at the time of the paging beacon delivery and sends an association request to the AP after receiving the paging beacon. Thus, following the paging beacon, a scheduled (re)association time period allows the access point to accept new association and re-association request or other uplink traffic. The (re)association time period is scheduled and advertised and the access point is in the awake mode to conduct desired operations.

By now it should be apparent that embodiments have been presented that extend power savings to access points using the idle mode service and the idle mode mechanism. Radio systems may be collocated in the platform of a communications device and use the algorithm to provide the capability of powering down the radio during the AP idle times. The algorithm presented in the flow chart of FIG. 3 describes a power savings scheme for an access point. By extending the idle mode mechanism to access points and to mobile devices (STA), there is a power savings that benefits all WLAN entities. Thus, the client and the AP may share a cooperative idle mode mechanism to efficiently manage power for all devices operating in the WLAN. Also, Wireless Network Interface Cards (NICs) may use the power savings scheme to improve WLAN standby hours for access points.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A wireless device operating as an access point, comprising:
a transceiver coupled to an antenna to receive a signal; and
a processor to receive the signal and having an idle mode service to control placing the access point in an idle mode.

2. The wireless device of claim 1 wherein the idle mode service is responsible for managing paging requests and broadcasting paging messages.

3. The wireless device of claim 1 wherein the idle mode service in the AP cooperatively shares idle mode information with a mobile device operating in a Wireless Local Area Network (WLAN) to manage power for all devices.

4. The wireless device of claim 1 wherein the AP turns off radios in the idle mode to save power and remains capable of providing network connectivity service for mobile clients.

5. An Access Point (AP) capable of operating in a Wireless Local Area Network (WLAN), comprising:
a radio; and
a processor coupled to the radio and having an idle mode service capable of determining that all STAs associated with the AP are in an idle mode and an idle mode controller to confirm the AP doesn't have any downlink or buffered network traffic.

6. The access point of claim 5 wherein the idle mode service and the idle mode controller power down the radio during AP idle times.

7. The access point of claim 5 wherein a client and the AP share information through the idle mode service to manage power for devices operating in the WLAN.

8. An Access Point (AP) capable of operating in a Wireless Local Area Network (WLAN), comprising:
a transceiver to receive paging information; and
a processor having at least two embedded cores and a paging controller to receive the paging information to determine that all STAs associated with the AP are in an idle mode and an idle mode controller to operate the AP in an idle mode.

9. The access point of claim 8 wherein prior to the AP operating in the idle mode, the AP confirms there is no downlink or buffered network traffic.

10. The access point of claim 8 wherein the paging controller switches the AP to a sleep mode and wakes the AP from the sleep mode to send a beacon every beacon interval.

11. The access point of claim 8 wherein the paging controller advertises an idle mode capability, a paging beacon interval, and a number of beacon frames to appear before a next paging beacon interval.

12. A method to dynamically adapt power in an Access Point (AP), comprising:
determining that all STAs associated with the AP are in an idle mode and that the AP doesn't have downlink or buffered network traffic; and
entering, by the AP, an idle operating mode.

13. The method of claim 12 further including:
operating the AP in a sleep mode;
waking the AP to send a beacon every beacon interval; and
returning the AP to operate in the sleep mode.

14. The method of claim 12 further including:
advertising, by the AP, an idle mode capability.

15. The method of claim 12 further including:
advertising, by the AP, a paging beacon interval.

16. The method of claim 12 further including:
advertising, by the AP, a number of beacon frames to appear before a next paging beacon interval.

17. The method of claim 12 further including:
determining, by the AP, that a current beacon is a paging beacon where the AP remains awake for an interval before a next beacon to accept new (re)association requests, probe requests from an idle mode station or unassociated station.

18. An operating Wireless Local Area Network (WLAN), comprising:
a mobile device operating in the WLAN; and
an Access Point (AP) broadcasting paging messages and receiving a response to indicate that the associated mobile device is in an idle mode, wherein the AP not having buffered network traffic enters an idle operating mode to save power.

19. The operating WLAN of claim 18 wherein the AP further includes a paging controller to cooperatively share idle mode information transmitted between the mobile device and the AP to manage power for the WLAN.

20. The operating WLAN of claim 19 wherein the paging controller advertises an idle mode capability, a paging beacon interval, and a number of beacon frames to appear before a next paging beacon interval.
